(19) United States
(12) Patent Application Publication
(10) Pub. No.: US 2025/0094429 A1
(43) Pub. Date: Mar. 20, 2025

(54) INTELLIGENT GROUPING OF MESSAGES INTO CONVERSATION DOCUMENTS FOR RANKING AND RETRIEVAL

(71) Applicant: Glean Technologies, Inc., Palo Alto, CA (US)

(72) Inventors: Krishnan Raghavan, Bengaluru (IN); Piyush Prahladka, Los Altos, CA (US); Hemant Kumar Chodipilli, Visakhapatnam (IN); Prashant Kumar, Patna (IN); Yash Chandnani, Jaipur (IN); Debarghya Das, Mountain View, CA (US)

(73) Assignee: Glean Technologies, Inc., Palo Alto, CA (US)

(21) Appl. No.: 18/467,724

(22) Filed: Sep. 14, 2023

(51) Int. Cl. G06F 16/2457; G06F 16/22; G06F 16/248; G06F 16/28

(52) U.S. Cl. CPC G06F 16/24578; G06F 16/22; G06F 16/248; G06F 16/285

(57) ABSTRACT

Methods and apparatuses for identifying groups of electronic messages, generating conversation documents using the groups of electronic messages, and indexing the conversation documents to improve search ranking and retrieval for content contained within the electronic messages are described. In some cases, understanding the contents of a group of electronic messages may require context from outside the group of electronic messages, such as context provided by electronic messages outside of the group of electronic messages or context provided by electronic documents linked to by messages of the group of electronic messages. The identification of a group of electronic messages includes detecting a conversation boundary that separates a first set of messages from a second set of messages, which may be determined using machine learning approaches or various heuristics.

### BACKGROUND

Individuals associated with an organization (e.g., a company or business entity) may have restricted access to electronic documents and data that are stored across various data repositories and data stores, such as enterprise databases and cloud-based data storage services. The data may comprise unstructured data or structured data (e.g., the data may be stored within a relational database). A search engine may allow the data to be indexed, searched, and displayed to authorized users that have permission to access or view the data. A user of the search engine may provide a textual search query to the search engine and in return the search engine may display the most relevant search results for the search query as links to electronic documents, web pages, electronic messages, images, videos, and other digital content. To determine the most relevant search results, the search engine may search for relevant information within a search index for the data and then score and rank the relevant information. In some cases, an electronic document indexed by the search engine may have an associated access control list (ACL) that includes access control entries that identify the access rights that the user has to the electronic document. The most relevant search results for the search query that are displayed to the user may comprise links to electronic documents and other digital content that the user is authorized to access in accordance with access control lists for the underlying electronic documents and other digital content.

### BRIEF SUMMARY

Systems and methods for intelligently identifying groups of electronic messages, generating conversation documents using the groups of electronic messages, and indexing the conversation documents to improve search ranking and retrieval for content contained within the electronic messages (or messages) are provided. In some cases, understanding of the contents of a group of messages may require context from outside the group of messages, such as context provided by other electronic messages outside of the group of messages or context provided by an electronic document referenced by one or more messages of the group of messages. The identification of the group of messages may include detecting a conversation boundary that separates the group of messages from a second set of messages. The conversation boundary may be determined using machine learning approaches or various heuristics. In some cases, the group of messages may be identified based on the time differences between messages of the group of messages, the usernames associated with the messages, the number of responses to each message of the group of messages, the type of messaging channel into which the group of messages was posted or displayed, and/or the total number of messages within the group of messages.

After a group of messages has been identified, the group of messages may be stored in a conversation document that is indexed by a search and knowledge management system. Along with the group of messages, headings, titles, and summaries may be automatically generated (e.g., using generative AI techniques) and inserted within the conversation document prior to indexing. In some cases, documents referenced by or linked to within messages of the group of messages may be summarized using a generative model and a summary of a referenced document may be embedded within the conversation document prior to indexing. Moreover, context information associated with messages of the group of messages, such as usernames of users who submitted messages and identified subject matter, may be embedded within the conversation document prior to indexing by the search and knowledge management system.

According to some embodiments, the technical benefits of the systems and methods disclosed herein include reduced energy consumption and cost of computing resources, increased quality of search results, increased reliability of information provided to search users, and improved search system performance.

This Summary is provided to introduce a brief description of some aspects of the disclosed technologies in a simplified form that are further described below in the Detailed Description. This Summary is not intended to identify key features or essential features of the claimed subject matter, nor is it intended that this Summary be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

Like-numbered elements may refer to common components in the different figures.

FIG. 1 depicts one embodiment of a networked computing environment.

FIG. 2A depicts one embodiment of a search and knowledge management system.

FIGS. 2B-2D depict various embodiments of a search and knowledge management system.

FIG. 3A depicts one embodiment of a mobile device providing a user interface for posting, viewing, and interacting with messages within a chat channel.

FIG. 3B depicts one embodiment of a first group of messages and a second group of messages.

FIG. 3C depicts one embodiment of a first conversation document and a second conversation document.

FIGS. 4A-4B depict a flowchart describing one embodiment of a process for generating, indexing, and utilizing conversation documents that aggregate electronic messages.

FIG. 4C depicts a flowchart describing one embodiment of a process for generating, indexing, and utilizing a conversation document.

### DETAILED DESCRIPTION

Technology is described for intelligently identifying groups of electronic messages, generating conversation documents using the groups of electronic messages, and indexing the conversation documents to improve search ranking and retrieval for content contained within the electronic messages. The electronic messages may correspond with chat messages within a chat channel, email messages, online text messages, instant messages, and/or electronic messages associated with a speech to text meeting transcript. In some cases, the electronic messages may correspond with messages within one or more message threads or conversation threads. In one example, a conversation thread may be associated with a stack overflow thread in which multiple users are involved in generating messages discussing a particular topic. In another example, a messaging thread may include a first group of electronic messages associated with a first topic and a second group of electronic messages associated with a second topic. In some cases, understanding the contents of an individual electronic message may require context from outside the individual message, such as context provided by subsequent and/or preceding electronic messages or context provided from the contents of electronic documents referred to or linked to by the subsequent and/or preceding electronic messages.

In some embodiments, the identification of a group of electronic messages (or messages) includes detecting a conversation boundary that separates a first set of messages from a second set of messages. The first set of messages may comprise a first set of contiguous messages within an application (e.g., an instant messaging application) that discuss a first topic or subject and the second set of messages may comprise a second set of contiguous messages within the application that discuss a second topic or subject that is different from the first topic or subject. A conversation boundary corresponding with where the first set of messages ends (or the last message of the first set of messages) and the second set of messages begins (or the first message of the second set of messages) may be determined using machine learning techniques. In one example, the machine learning techniques may be used to identify channel level signals for starting a new group of messages or ending a prior group of messages. A machine learning model may be trained to identify a conversation boundary given a training data set that includes messages for numerous conversation threads and an identification of which messages comprise root messages (or start messages) and ending messages for each conversation thread.

In some cases, each message within a group of electronic messages may correspond with messages within the same application (e.g., messages from the same instant messaging application). In one example, each message within the group of electronic messages may comprise messages within one or more chat channels of an instant messaging application that occur between two conversation boundaries. In other cases, a group of electronic messages may include a first set of messages from a first application (e.g., a chat application) and a second set of messages from a second application (e.g., an email application). In this case, the grouping of electronic messages includes messages from two or more applications. The grouping of electronic messages may be determined based on a subject matter or topic extracted from the message contents of a message and/or a time and date corresponding to when the message was posted or received. In one example, the grouping of electronic messages may comprise electronic messages posted or received within a particular time period that include message contents that are associated with a particular subject matter.

In some embodiments, a first message (or a new root message) of a group of messages may be identified using metadata associated with the first message. The metadata may include a time that the first message was displayed or submitted and a username corresponding with the first message. In one example, the first message of the group of messages may be identified upon detection that more than a threshold amount of time has passed since a previous message (e.g., more than two hours have elapsed since the previous message) and/or detection that the first message corresponds with a new username that has not been used during a previous set of messages (e.g., has not been used for the past 50 messages). In some embodiments, a first message of a group of messages may be identified using metadata associated with the first message and message content of the first message. In one example, a topic or subject may be determined for a prior set of messages and the first message may be identified upon detection that the first message includes message content of a new topic or subject that differs from the topic or subject of the prior set of messages. The identification of a first message (or a new root message) may also determine a conversation boundary between messages corresponding with a different group of messages that preceded the first message and the first message of the group of messages.

In some cases, a group of messages may be identified based on the time differences between messages of the group of messages, the usernames associated with the messages, the number of responses to each message, the type of messaging channel, and/or the total number of messages within the group of messages. In one example, each grouping of messages may comprise at most a maximum number of messages that is determined based on the type of messaging channel (e.g., whether the messaging channel is a private channel that is accessible by only a limited number of users or is accessible by any user of a messaging application). The maximum number of messages per grouping may be set based on the number of users within a chat channel, the number of users who are subscribed to the chat channel, or the number of users who have posted messages to the chat channel within a threshold period of time (e.g., within the past two hours).

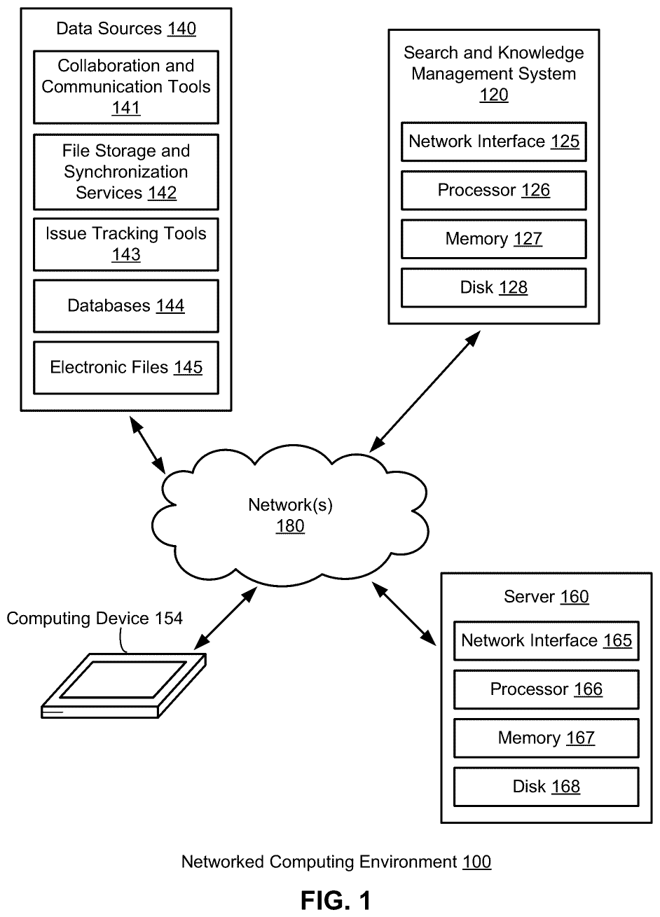

After a grouping of messages has been identified, the group of messages may be stored in a conversation document that is indexed by a search and knowledge management system, such as the search and knowledge management system 120 in FIG. 1. Along with the contents of the group of messages, headings, titles, and summaries may be automatically generated (e.g., using generative AI techniques) and inserted within the conversation document prior to indexing. Generative AI may refer to unsupervised and/or semi-supervised machine learning algorithms that are used to generate new content, such as newly generated text, code, images, audio and video content. In some cases, documents referenced by or linked to within messages of the group of messages may be summarized using a generative model and a summary of each document may be embedded within the conversation document prior to indexing. Moreover, context information associated with messages of the group of messages, such as usernames of users who submitted messages and identified subject matter classifications, may be embedded within the conversation document prior to indexing.

One technical issue with generating conversation documents from groups of messages for search indexing is that search context may be missing from individual messages making retrieval of relevant information difficult. Further, a technical issue with identifying groups of messages associated with a common conversation (e.g., covering a common topic or subject) is that the content of individual messages may leave out important context that is necessary to determine conversation boundaries between the groups of messages. The technical benefits of identifying groups of electronic messages and then generating conversation documents using the groups of electronic messages for search indexing include improved quality and relevance of search results. A technical benefit of aggregating individual messages into conversation documents and adding in additional context found in documents outside of the individual messages (e.g., from emails or recently edited documents) to the conversation documents prior to search indexing includes improved quality and relevance of search results, improved quality and relevant of responses provided by automated question answering systems, and improved search system performance.

A permissions-aware search and knowledge management system may enable digital content (or content) stored across a variety of local and cloud-based data stores to be indexed, searched, and displayed to authorized users. The searchable content may comprise data or text embedded within electronic documents, hypertext documents, text documents, web pages, electronic messages, instant messages, database fields, digital images, and wikis. An enterprise or organization may restrict access to the digital content over time by dynamically restricting access to different sets of data to different groups of people using access control lists (ACLs) or authorization lists that specify which users or groups of users of the permissions-aware search and knowledge management system may access, view, or alter particular sets of data. A user of the permissions-aware search and knowledge management system may be identified via a unique username or a unique alphanumeric identifier. In some cases, an email address or a hash of the email address for the user may be used as the primary identifier for the user. To determine whether a user executing a search query has sufficient access rights to view particular search results, the permissions-aware search and knowledge management system may determine the access rights via ACLs for sets of data (e.g., for multiple electronic documents) underlying the particular search results at the time that the search is executed by the user or prior to the display of the particular search results to the user (e.g., the access rights may have been set when the sets of data underlying the particular search results were indexed).

To determine the most relevant search results for the user's search query, the permissions-aware search and knowledge management system may identify a number of relevant documents within a search index for the searchable content that satisfy the user's search query. The relevant documents (or items) may then be ranked by determining an ordering of the relevant documents from the most relevant document to the least relevant document. A document may comprise any piece of digital content that can be indexed, such as an electronic message or a hypertext document. A variety of different ranking signals or ranking factors may be used to rank the relevant documents for the user's search query. In some embodiments, the identification and ranking of the relevant documents for the user's search query may take into account user suggested results from the user and/or other users (e.g., from co-workers within the same group as the user or co-located at the same level within a management hierarchy), the amount of time that has elapsed since a user suggested result was established, whether the underlying content was verified by a content owner of the content as being up-to-date or approved content, the amount of time that has elapsed since the underlying content was verified by the content owner, and the recent activity of the user and/or related group members (e.g., a co-worker within the same group as the user recently discussed a particular subject related to the executed search query within a messaging application within the past week).

In some embodiments, the permissions-aware search and knowledge management system may allow a user to search for content and resources across different workplace applications and data sources that are authorized to be viewed by the user. The permissions-aware search and knowledge management system may include a data ingestion and indexing path that periodically acquires content and identity information from different data sources and then adds them to a search index. The data sources may include databases, file systems, document management systems, cloud-based file synchronization and storage services, cloud-based applications, electronic messaging applications, and workplace collaboration applications. In some cases, data updates and new content may be pushed to the data ingestion and indexing path. In other cases, the data ingestion and indexing path may utilize a site crawler or periodically poll the data sources for new, updated, and deleted content. As the content from different data sources may contain different data formats and document types, incoming documents may be converted to plain text or to a normalized data format. The search index may include portions of text, text summaries, unique words, terms, and term frequency information per indexed document. In some cases, the text summaries may only be provided for documents that are frequently searched or accessed. A text summary may include the most relevant sentences, key words, personal names, and locations that are extracted from a document using natural language processing (NLP). The permissions-aware search and knowledge management system may utilize NLP and deep-learning models in order to identify semantic meaning within documents and search queries.

FIG. 1 depicts one embodiment of a networked computing environment 100 in which the disclosed technology may be practiced. The networked computing environment 100 includes a search and knowledge management system 120, one or more data sources 140, server 160, and a computing device 154 in communication with each other via one or more networks 180. The networked computing environment 100 may include a plurality of computing devices interconnected through one or more networks 180. The networked computing environment 100 may correspond with or provide access to a cloud computing environment providing Software-as-a-Service (SaaS) or Infrastructure-as-a-Service (IaaS) services. The one or more networks 180 may allow computing devices and/or storage devices to connect to and communicate with other computing devices and/or other storage devices. In some cases, the networked computing environment 100 may include other computing devices and/or other storage devices not shown. The other computing devices may include, for example, a mobile computing device, a non-mobile computing device, a server, a workstation, a laptop computer, a tablet computer, a desktop computer, or an information processing system. The other storage devices may include, for example, a storage area network storage device, a networked-attached storage device, a hard disk drive, a solid-state drive, a data storage system, or a cloud-based data storage system. The one or more networks 180 may include a cellular network, a mobile network, a wireless network, a wired network, a secure network such as an enterprise private network, an unsecure network such as a wireless open network, a local area network (LAN), a wide area network (WAN), the Internet, or a combination of networks.

In some embodiments, the computing devices within the networked computing environment 100 may comprise real hardware computing devices or virtual computing devices, such as one or more virtual machines. The storage devices within the networked computing environment 100 may comprise real hardware storage devices or virtual storage devices, such as one or more virtual disks. The real hardware storage devices may include non-volatile and volatile storage devices.

The search and knowledge management system 120 may comprise a permissions-aware search and knowledge management system that utilizes user suggested results, document verification, and user activity tracking to generate or rank search results. The search and knowledge management system 120 may enable content stored in storage devices throughout the networked computing environment 100 to be indexed, searched, and displayed to authorized users. The search and knowledge management system 120 may index content stored on various computing and storage devices, such as data sources 140 and server 160, and allow a computing device, such as computing device 154, to input or submit a search query for the content and receive authorized search results with links or references to portions of the content. As the search query is being typed or entered into a search bar on the computing device, potential additional search terms may be displayed to help guide a user of the computing device to enter a more refined search query. This autocomplete assistance may display potential word completions and potential phrase completions within the search bar.

As depicted in FIG. 1, the search and knowledge management system 120 includes a network interface 125, processor 126, memory 127, and disk 128 all in communication with each other. The network interface 125, processor 126, memory 127, and disk 128 may comprise real components or virtualized components. In one example, the network interface 125, processor 126, memory 127, and disk 128 may be provided by a virtualized infrastructure or a cloud-based infrastructure. Network interface 125 allows the search and knowledge management system 120 to connect to one or more networks 180. Network interface 125 may include a wireless network interface and/or a wired network interface. Processor 126 allows the search and knowledge management system 120 to execute computer readable instructions stored in memory 127 in order to perform processes described herein. Processor 126 may include one or more processing units, such as one or more CPUs and/or one or more GPUs. Memory 127 may comprise one or more types of memory (e.g., RAM, SRAM, DRAM, EEPROM, Flash, etc.). Disk 128 may include a hard disk drive and/or a solid-state drive. Memory 127 and disk 128 may comprise hardware storage devices.

In one embodiment, the search and knowledge management system 120 may include one or more hardware processors and/or one or more control circuits for performing a permissions-aware search in which a ranking of search results is outputted or displayed in response to a search query. The search results may be displayed using snippets or summaries of the content. In some embodiments, the search and knowledge management system 120 may be implemented using a cloud-based computing platform or cloud-based computing and data storage services.

The data sources 140 include collaboration and communication tools 141, file storage and synchronization services 142, issue tracking tools 143, databases 144, and electronic files 145. The data sources 140 may include a communication platform not depicted that provides online chat, threaded conversations, videoconferencing, file storage, and application integration. The data sources 140 may comprise software and/or hardware used by an organization to store its data. The data sources 140 may store content that is directly searchable, such as text within text files, word processing documents, presentation slides, and spreadsheets. For audio files or audiovisual content, the audio portion may be converted to searchable text using an audio to text converter or transcription application. For image files and videos, text within the images may be identified and extracted to provide searchable text. The collaboration and communication tools 141 may include applications and services for enabling communication between group members and managing group activities, such as electronic messaging applications, electronic calendars, and wikis or hypertext publications that may be collaboratively edited and managed by the group members. The electronic messaging applications may provide persistent chat channels that are organized by topics or groups. The collaboration and communication tools 141 may also include distributed version control and source code management tools. The file storage and synchronization services 142 may allow users to store files locally or in the cloud and synchronize or share the files across multiple devices and platforms. The issue tracking tools 143 may include applications for tracking and coordinating product issues, bugs, and feature requests. The databases 144 may include distributed databases, relational databases, and NoSQL databases. The electronic files 145 may comprise text files, audio files, image files, video files, database files, electronic message files, executable files, source code files, spreadsheet files, and electronic documents that allow text and images to be displayed consistently independent of application software or hardware.

The computing device 154 may comprise a mobile computing device, such as a tablet computer, that allows a user to access a graphical user interface for the search and knowledge management system 120. A search interface may be provided by the search and knowledge management system 120 to search content within the data sources 140. A search application identifier may be included with every search to preserve contextual information associated with each search. The contextual information may include the data sources and search rankings that were used for the search using the search interface.

A server, such as server 160, may allow a client device, such as the computing device 154, to download information or files (e.g., executable, text, application, audio, image, or video files) from the server or to enable a search query related to particular information stored on the server to be performed. The search results may be provided to the client device by a search engine or a search system, such as the search and knowledge management system 120. The server 160 may comprise a hardware server. In some cases, the server may act as an application server or a file server. In general, a server may refer to a hardware device that acts as the host in a client-server relationship or to a software process that shares a resource with or performs work for one or more clients. The server 160 includes a network interface 165, processor 166, memory 167, and disk 168 all in communication with each other. Network interface 165 allows server 160 to connect to one or more networks 180. Network interface 165 may include a wireless network interface and/or a wired network interface. Processor 166 allows server 160 to execute computer readable instructions stored in memory 167 in order to perform processes described herein. Processor 166 may include one or more processing units, such as one or more CPUs and/or one or more GPUs. Memory 167 may comprise one or more types of memory (e.g., RAM, SRAM, DRAM, EEPROM, Flash, etc.). Disk 168 may include a hard disk drive and/or a solid-state drive. Memory 167 and disk 168 may comprise hardware storage devices.

The networked computing environment 100 may provide a cloud computing environment for one or more computing devices. In one embodiment, the networked computing environment 100 may include a virtualized infrastructure that provides software, data processing, and/or data storage services to end users accessing the services via the networked computing environment. In one example, networked computing environment 100 may provide cloud-based work productivity applications to computing devices, such as computing device 154. The networked computing environment 100 may provide access to protected resources (e.g., networks, servers, storage devices, files, and computing applications) based on access rights (e.g., read, write, create, delete, or execute rights) that are tailored to particular users of the computing environment (e.g., a particular employee or a group of users that are identified as belonging to a particular group or classification).

An access control system may perform various functions for managing access to resources including authentication, authorization, and auditing. Authentication may refer to the process of verifying that credentials provided by a user or entity are valid or to the process of confirming the identity associated with a user or entity (e.g., confirming that a correct password has been entered for a given username). Authorization may refer to the granting of a right or permission to access a protected resource or to the process of determining whether an authenticated user is authorized to access a protected resource. Auditing may refer to the process of storing records (e.g., log files) for preserving evidence related to access control events. In some cases, an access control system may manage access to a protected resource by requiring authentication information or authenticated credentials (e.g., a valid username and password) before granting access to the protected resource. For example, an access control system may allow a remote computing device (e.g., a mobile phone) to search or access a protected resource, such as a file, web page, application, or cloud-based application, via a web browser if valid credentials can be provided to the access control system.

In some embodiments, the search and knowledge management system 120 may utilize processes that crawl the data sources 140 to identify and extract searchable content. The content crawlers may extract content on a periodic basis from files, websites, and databases and then cause portions of the content to be transferred to the search and knowledge management system 120. The frequency at which the content crawlers extract content may vary depending on the data source and the type of data being extracted. For example, a first update frequency (e.g., every hour) at which presentation slides or text files with infrequent updates are crawled may be less than a second update frequency (e.g., every minute) at which some websites or blogging services that publish frequent updates to content are crawled. In some cases, files, websites, and databases that are frequently searched or that frequently appear in search results may be crawled at the second update frequency (e.g., every two minutes) while other documents that have not appeared in search results within the past two days may be crawled at the first update frequency (e.g., once every two hours). The content extracted from the data sources 140 may be used to build a search index using portions of the content or summaries of the content. The search and knowledge management system 120 may extract metadata associated with various files and include the metadata within the search index. The search and knowledge management system 120 may also store user and group permissions within the search index. The user permissions for a document with an entry in the search index may be determined at the time of a search query or at the time that the document was indexed. A document may represent a single object that is an item in the search index, such as a file, folder, or a database record.

After the search index has been created and stored, then search queries may be accepted and ranked search results to the search queries may be generated and displayed. Only documents that are authorized to be accessed by a user may be returned and displayed. The user may be identified based on a username or email address associated with the user. The search and knowledge management system 120 may acquire one or more ACLs or determine access permissions for the documents underlying the ranked search results from the search index that includes the access permissions for the documents. The search and knowledge management system 120 may process a search query by passing over the search index and identifying content information that matches the search terms of the search query and synonyms for the search terms. The content associated with the matched search terms may then be ranked taking into account user suggested results from the user and others, whether the underlying content was verified by a content owner within a past threshold period of time (e.g., was verified within the past week), and recent messaging activity by the user and others within a common grouping. The authorized search results may be displayed with links to the underlying content or as part of personalized recommendations for the user (e.g., displaying an assigned task or a highly viewed document by others within the same group).

To generate the search index, a full crawl in which the entire content from a data source is fetched may be performed upon system initialization or whenever a new data source is added. In some cases, registered applications may push data updates; however, because the data updates may not be complete, additional full crawls may be performed on a periodic basis (e.g., every two weeks) to make sure that all data changes to content within the data sources are covered and included within the search index. In some cases, the rate of the full crawl refreshes may be adjusted based on the number of data update errors detected. A data update error may occur when documents associated with search results are out of date due to content updates or when documents associated with search results have had content changes that were not reflected in the search index at the time that the search was performed. Each data source may have a different full crawl refresh rate. In one example, full crawls on a database may be performed at a first crawl refresh rate and full crawls on files associated with a website may be performed at a second crawl refresh rate greater than the first crawl refresh rate.

An incremental crawl may fetch only content that was modified, added, or deleted since a particular time (e.g., since the last full crawl or since the last incremental crawl was performed). In some cases, incremental crawls or the fetching of only a subset of the documents from a data source may be performed at a higher refresh rate (e.g., every hour) on the most searched documents or for documents that have been flagged as having a at least a threshold number of data update errors, or that have been newly added to the organization's corpus that are searchable. In other cases, incremental crawls may be performed at a higher refresh rate (e.g., content changes are fetched every ten minutes) on a first set of documents within a data source in which content deletion occurs at a first deletion rate (e.g., some content is deleted at least every hour) and performed at a lower refresh rate (e.g., content changes are fetched every hour) on a second set of documents within the data source in which content deletion occurs at a second deletion rate (e.g., content deletions occur on a weekly basis). One technical benefit of performing incremental crawls on a subset of documents within a data source that comprise frequently searched documents or documents that have a high rate of data deletions is that the load on the data source may be reduced and the number of application programming interface (API) calls to the data source may be reduced.

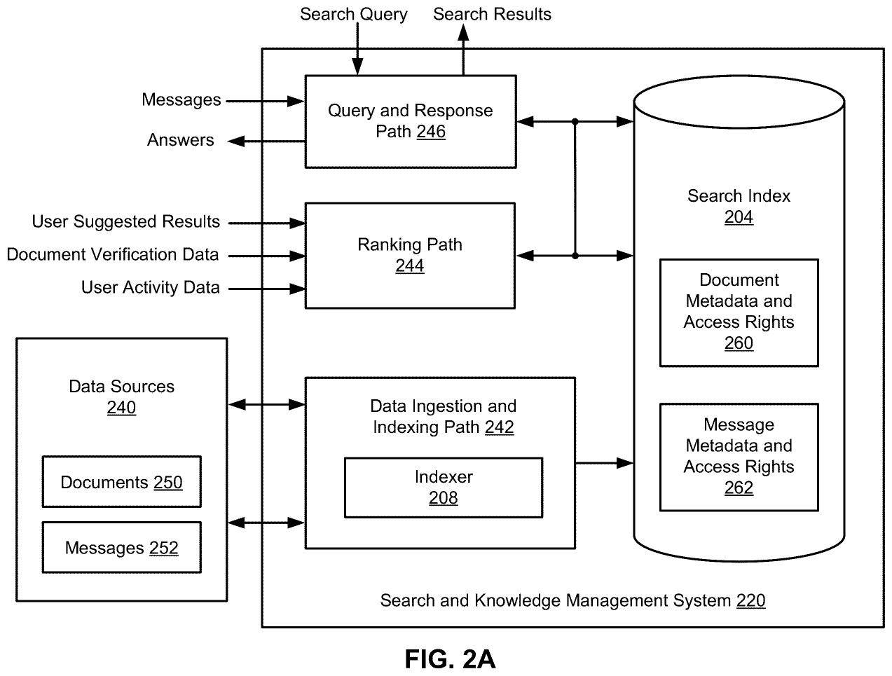

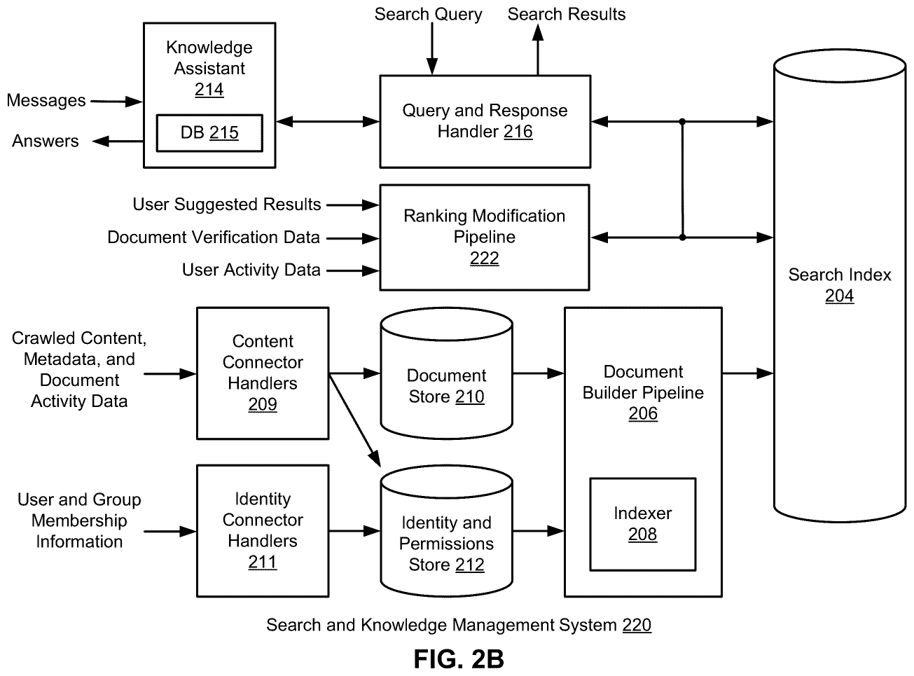

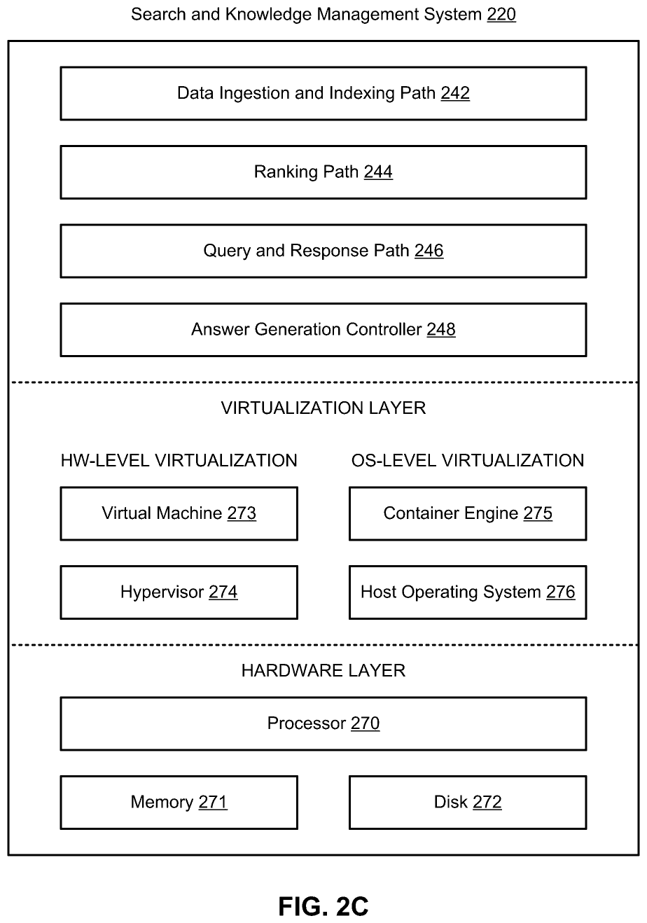

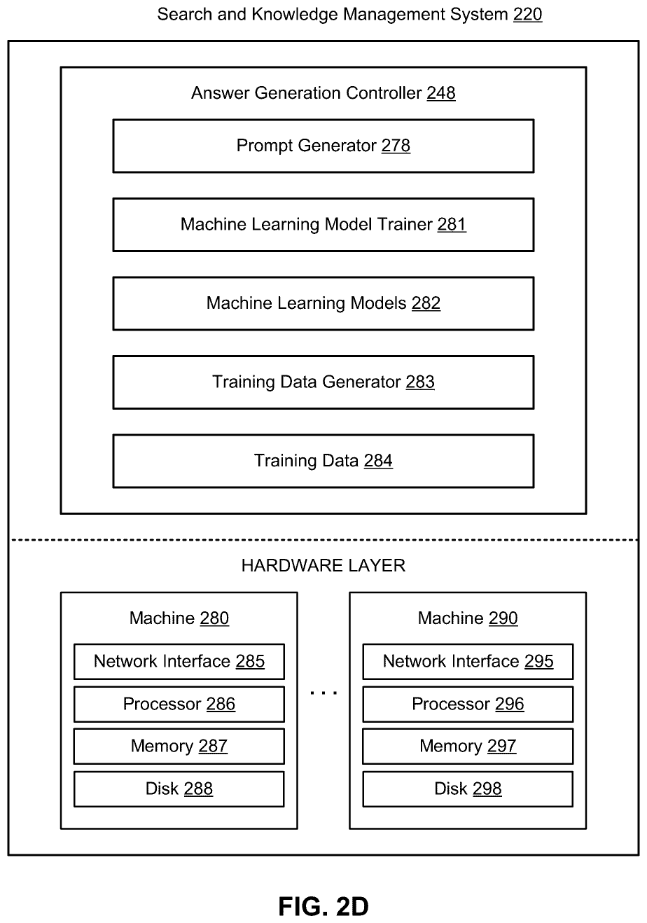

FIG. 2A depicts one embodiment of a search and knowledge management system 220 in communication with one or more data sources 240. In one embodiment, the search and knowledge management system 220 may comprise one implementation of the search and knowledge management system 120 in FIG. 1 and the data sources 240 may correspond with the data sources 140 in FIG. 1. The data sources 240 may include one or more electronic documents 250 and one or more electronic messages 252 that are stored over various networks, document and content management systems, file servers, database systems, desktop computers, portable electronic devices, mobile phones, cloud-based applications, and cloud-based services.

The search and knowledge management system 220 may comprise a cloud-based system that includes a data ingestion and index path 242, a ranking path 244, a query and response path 246, and a search index 204. The search index 204 may store a first set of index entries for the one or more electronic documents 250 including document metadata and access rights 260 and a second set of index entries for the one or more electronic messages 252 including message metadata and access rights 262. The data ingestion and index path 242 may crawl a corpus of documents within the data sources 240, index the documents and extract metadata for each document fetched from the data sources 240, and then store the metadata in the search index 204. An indexer 208 within the data ingestion and index path 242 may write the metadata to the search index 204. In one example, if a fetched document comprises a text file, then the metadata for the document may include information regarding the file size or number of words, an identification of the author or creator of the document, when the document was created and last modified, key words from the document, a summary of the document, and access rights for the document. The query and response path 246 may receive a search query from a user computing device, such as the computing device 154 in FIG. 1, and compare the search query and terms derived from the search query (e.g., synonyms and related terms) with the search index 204 to identify relevant documents for the search query. The query and response path 246 may also include or interface with an automated digital assistant that may interact with a user of the user computing device in a conversational manner in which answers are outputted in response to messages or questions provided to the automated digital assistant.

The relevant documents may be ranked using the ranking path 244 and then a set of search results responsive to the search query may be outputted to the user computing device corresponding with the ranking or ordering of the relevant documents. The ranking path 244 may take into consideration a variety of signals to score and rank the relevant documents. The ranking path 244 may determine the ranking of the relevant documents based on the number of times that a search query term appears within the content or metadata for a document, whether the search query term matches a key word for a document, and how recently a document was created or last modified. The ranking path 244 may also determine the ranking of the relevant documents based on user suggested results from an owner of a relevant document or the user executing the search query, the amount of time that has passed since the user suggested result was established, whether a document was verified by a content owner, the amount of time that has passed since the relevant document was verified by the content owner, and the amount and type of activity performed with a past period of time (e.g., within the past hour) by the user executing the search query and related group members.

FIG. 2B depicts one embodiment of the search and knowledge management system 220 of FIG. 2A. The search and knowledge management system 220 may comprise a cloud-based system that includes a data ingestion and indexing path, a ranking path, a query path, and a search index 204. The components of the search and knowledge management system 220 may be implemented using software, hardware, or a combination of hardware and software. In some cases, a cloud-based task service for asynchronous execution, cloud-based task handlers, or a cloud-based system for managing the execution, dispatch, and delivery of distributed tasks may be used to implement the fetching and processing of content from various data sources, such as data sources 240 in FIG. 2A. In some cases, a cloud-based task service or a cloud-based system for managing the execution, dispatch, and delivery of distributed tasks may be used to acquire and synchronize user and group identifications associated with content fetched from the various data sources. The data sources may have dedicated task queues or shared task queues depending on the size of the data source and the rate requirements for fetching the content. In one example, a data source may have a dedicated task queue if the data source stores more than a threshold number of documents or more than a threshold amount of content (e.g., stores more than 100 GB of data).

The data ingestion and indexing path is responsible for periodically acquiring content and identity information from the data sources 240 in FIG. 2A and adding the content and identity information or portions thereof to the search index 204. The data ingestion and indexing path includes content connector handlers 209 in communication with document store 210. The document store 210 may comprise a key value store database or a cloud-based database service. The content connector handlers 209 may comprise software programs or applications that are used to traverse and fetch content from one or more data sources. The content connector handlers 209 may make API calls to various data sources, such as the data sources 240 in FIG. 2A, to fetch content and data updates from the data sources. Each data source may be associated with one content connector for that data source. The content connector handlers 209 may acquire content, metadata, and activity data corresponding with the content. For example, the content connector handlers 209 may acquire the text of a word processing document, metadata for the word processing document, and activity data for the word processing document. The metadata for the word processing document may include an identification of the owner of the document, a timestamp associated with when the document was last modified, a file size for the document, and access permissions for the document. The activity data for the word processing document may include the number of views for the document within a threshold period of time (e.g., within the past week or since the last update to the document occurred), the number of likes for the document, the number of downloads for the document, and the number of shares associated with the document. The content connector handlers 209 may store the fetched content, metadata, and activity data in the document store 210 and publish the fetch event to a publish-subscribe (pubsub) system not depicted so that the document builder pipeline 206 may be notified that the fetch event has occurred. In response to the notification, the document builder pipeline 206 may process the fetched content and add the fetched content and information derived from the fetched content to the search index 204. The document builder pipeline 206 may transform or augment the fetched content prior to storing the information derived from the fetched content in the search index 204. In one example, the document builder pipeline 206 may augment the fetched content with identity information and synonyms.

Some data sources may utilize APIs that provide notification (e.g., via webhook pings) to the content connector handlers 209 that content within a data source has been modified, added, or deleted. For data sources that are not able to provide notification that content updates have occurred or that cannot push content changes to the content connector handlers 209, the content connector handlers 209 may perform periodic incremental crawls in order to identify and acquire content changes. In some cases, the content connector handlers 209 may perform periodic incremental crawls or full crawls even if a data source has provided webhook pings in the past in order to ensure the integrity of the acquired content and that the search and knowledge management system 220 is consistent with the actual state of the content stored in the data source. Some data sources may allow applications to register for callbacks or push notifications whenever content or identity information has been updated at the data source.

As depicted in FIG. 2B, the data ingestion and indexing path also includes identity connector handlers 211 in communication with identity and permissions store 212. The identity and permissions store 212 may comprise a key value store database or a cloud-based database service. The identity connector handlers 211 may acquire user and group membership information from one or more data sources and store the user and group membership information in the identity and permissions store 212 to enable search results that respect data source specific privacy settings for the content stored using the one or more data sources. The user information may include data source specific user information, such as a data source specific user identification or username. The identity connector handlers 211 may comprise software programs or applications that are used to acquire and synchronize user and/or group identities to a primary identity used by the search and knowledge management system 220 to uniquely identify a user. Each user of the search and knowledge management system 220 may be canonically represented via a unique primary identity, which may comprise a hash of an email address for the user. In some cases, the search and knowledge management system 220 may map an email address that is used as the primary identity for a user to an alphanumeric username used by a data source to identify the same user. In other cases, the search and knowledge management system 220 may map a unique alphanumeric username that is used as the primary identity for a user to two different usernames that are used by a data source to identify the same user, such as one username associated with regular access permissions and another username associated with administrative access permissions. If a data source does not identify a user by the user's primary identity within the search and knowledge management system 220, then an external identity that identifies the user for that data source may be determined by the search and knowledge management system 220 and mapped to the primary identity.

In some cases, the content connector handlers 209 may fetch access rights and permissions settings associated with the fetched content during the content crawl and store the access rights and permission settings using the identity and permissions store 212. For some data sources, the identity crawl to obtain user and group membership information may be performed before the content crawl to obtain content associated with the user and group membership information. When a document is fetched during the content crawl, the content connector handlers 209 may also fetch the ACL for the document. The ACL may specify the allowed users with the ability to view or access the document, the disallowed users that do not have access rights to view or access the document, allowed groups with the ability to view or access the document, and disallowed groups that do not have access rights to view or access the document. The ACL for the document may indicate access privileges for the document including which individuals or groups have read access to the document.

In some cases, a particular set of data may be associated with an ACL that determines which users within an organization may access the particular set of data. In one example, to ensure compliance with data security and retention regulations, the particular set of data may comprise sensitive or confidential information that is restricted to viewing by only a first group of users. In another example, the particular set of data may comprise source code and technical documentation for a particular product that is restricted to viewing by only a second group of users.

As depicted in FIG. 2B, the document store 210 may store crawled content from various data sources, along with any transformation or processing of the content that occurs prior to indexing the crawled content. Every piece of content acquired from the data sources may correspond with a row in the document store 210. For example, when the content connector handlers 209 fetch a spreadsheet or word processing document from a data source, the raw content for the spreadsheet or word processing document may be stored as a row in the document store 210. In addition to the raw content, a row in the document store 210 may also include interaction or activity data associated with the content, such as the number of views, the number of comments, the number of likes, and the number of users who interacted with the content along with their corresponding user identifications. A row in the document store 210 may also include document metadata for the stored content, such as keywords or classification information, and permissions or access rights information for the stored content.

The identity and permissions store 212 may store the primary identity for a user (e.g., a hash of an email address) within the search and knowledge management system 220 and corresponding usernames or data source identifiers used by each data source for the same user. A row in the identity and permissions store 212 may include a mapping from the user identifier used by a data source to the corresponding primary identity for the user for the search and knowledge management system 220. The identity and permissions store 212 may also store identifications for each user assigned to a particular group or associated with a particular group membership. The ACLs that are associated with a fetched document may include allowed user identifications and allowed group identifications. Each user of the search and knowledge management system 220 may correspond with a unique primary identity and each primary identity may be mapped to all groups that the user is a member of across all data sources.

As depicted in FIG. 2B, the data ingestion and indexing path includes document builder pipeline 206 in communication with search index 204. The document builder pipeline 206 may comprise software programs or applications that are used to transform or augment the crawled content to generate searchable documents that are then stored within the search index 204. The document builder pipeline 206 may include an indexer 208 that writes content derived from the fetched content, structured metadata for the fetched content, and access rights for the fetched content to the search index 204.

The searchable documents generated by the document builder pipeline 206 may comprise portions of the crawled content along with augmented data, such as access right information, document linking information, search term synonyms, and document activity information. In one example, the document builder pipeline 206 may transform the crawled content by extracting plain text from a word processing document, a hypertext markup language (HTML) document, or a portable document format (PDF) document and then directing the indexer 208 to write the plain text for the document to the search index 204. A document parser may be used to extract the plain text for the document or to generate clean text for the document that can be indexed (e.g., with HTML tags or text formatting tags removed). The document builder pipeline 206 may also determine access rights for the document and write the identifications for the users and groups with access rights to the document to the search index 204. The document builder pipeline 206 may determine document linking information for the crawled document, such as a list of all the documents that reference the crawled document and their anchor descriptions, and store the document linking information in the search index 204. The document linking information may be used to determine document popularity (e.g., based on how many times a document is referenced or the number of outlinks from the document) and preserve searchable anchor text for target documents that are referenced. The words or terms used to describe an outgoing link in a source document may provide an important ranking signal for the linked target document if the words or terms accurately describe the target document. The document builder pipeline 206 may also determine document activity information for the crawled document, such as the number of document views, the number of comments or replies associated with the document, and the number of likes or shares associated with the document, and store the document activity information in the search index 204.

The document builder pipeline 206 may be subscribed to publish-subscribe events that get written by the content connector handlers 209 every time new documents or updates are added to the document store 210. Upon notification that the new documents or updates have been added to the document store 210, the document builder pipeline 206 may perform processes to transform or augment the new documents or portions thereof prior to generating the searchable documents to be stored within the search index 204.

As depicted in FIG. 2B, the query path includes a query and response handler 216 in communication with the search index 204 and the ranking modification pipeline 222. A knowledge assistant 214 interacts with the query and response handler 216 to provide a real-time automated digital assistant that may interact with a user of the search and knowledge management system 220 via a graphical user interface in a conversational manner using natural language dialog. The automated digital assistant may comprise a computer-implemented assistant that may access and display only information that a user's access rights permit. The knowledge assistant 214 may include a frequently asked questions (FAQ) database that includes question and answer pairs for questions identified within a chat channel that were classified as factual questions. The FAQ database may be stored in database DB 215 or in a solid-state memory not depicted.

The query and response handler 216 may comprise software programs or applications that detect that a search query has been submitted by an authenticated user identity, parse the search query, acquire query metadata for the search query, identify a primary identity for the authenticated user identity, acquire ranked search results that satisfy the search query using the primary identity and the parsed search query, and output (e.g., transfer or display) the ranked search results that satisfy the search query or that comprise the highest ranking of relevant information for the search query and the query metadata. The search query may be parsed by acquiring an inputted search query string for the search query and identifying root terms or tokenized terms within the search query string, such as unigrams and bigrams, with corresponding weights and synonyms. In some cases, natural language processing algorithms may be used to identify terms within a search query string for the search query. The search query may be received as a string of characters and the natural language processing algorithms may identify a set of terms (or a set of tokens) from the string of characters. Potential spelling errors for the identified terms may be detected and corrected terms may be added or substituted for the potentially misspelled terms.

The query metadata may include synonyms for terms identified within the search query and nearest neighbors with semantic similarity (e.g., with semantic similarity scores above a threshold that indicate their similarity to each other at the semantic level). The semantic similarity between two texts (e.g., each comprising one or more words) may refer to how similar the two texts are in meaning. A supervised machine learning approach may be used to determine the semantic similarity between the two texts in which training data for the supervised step may include sentence or phrase pairs and the associated labels that represent the semantic similarly between the sentence or phrase pairs. The query and response handler 216 may consume the search query as a search query string, and then construct and issue a set of queries related to the search query based on the terms identified within the search query string and the query metadata. In response to the set of queries being issued, the query and response handler 216 may acquire a set of relevant documents for the set of queries from the search index 204. The set of relevant documents may be provided to the ranking modification pipeline 222 to be scored and ranked for relevance to the search query. After the set of relevant documents have been ranked, a subset of the set of relevant documents may be identified (e.g., the top thirty ranked documents) based on the ranking and summary information or snippets may be acquired from the search index 204 for each document of the subset of the set of relevant documents. The query and response handler 216 may output the ranked subset of the set of relevant documents and their corresponding snippets to a computing device used by the authenticated user, such as the computing device 154 in FIG. 1.

Moreover, when a user issues a search query, the query and response handler 216 may determine the primary identity for the authenticated user and then query the identity and permissions store 212 to acquire all groups that the user is a member of across all data sources. The query and response handler 216 may then query the search index 204 with a filter that restricts the retrieved set of relevant documents such that the ACLs for the retrieved documents permit the user to access or view each of the retrieved set of relevant documents. In this case, each ACL should either specify that the user comprises an allowed user or that the user is a member of an allowed group.

The search index 204 may comprise a database that stores searchable content related to documents stored within the data sources 240 in FIG. 2A. The search index 204 may store text, title strings, chat message bodies, metadata, and access rights related to searchable content. For each searchable document, portions of text associated with the document, extracted key words, document classifications, and document summaries may be stored within the search index 204. For searchable electronic messages (e.g., searchable chat messages or email messages), the title, the message body of the original message, and the message bodies of related messages may be stored within the search index 204. For searchable question and answer responses, the message body of the question and the message body of the answer may be stored within the search index 204. A question and answer pair may derive from questions and answers made by the user or made by other users (e.g., co-workers) during a conversation exchange within a persistent chat channel or from dialog between an artificial intelligence powered digital assistant and the user within a chat channel. One example of an artificial intelligence powered digital assistant is the knowledge assistant 214 that may automatically output answers to messages or questions provided to the digital assistant. Text associated with other documents linked to or referenced by a searchable document, electronic message, or question and answer pair may also be stored within the search index 204 to provide context for the searchable content. Content access rights including which users and groups are allowed to access the content may be stored within the search index 204 for each piece of searchable content.

As depicted in FIG. 2B, the ranking modification pipeline 222 may comprise software programs or applications that are used to score and rank documents and portions of documents. The scoring of a set of relevant documents may weight different attributes of the documents differently. In one example, literal matches or lexical matches of search query terms within the body of a message or document may correspond with a first weighting while semantic matches of the search query terms may correspond with a second weighting different from the first weighting (e.g., greater than the first weighting). The matching of search query terms or their synonyms within a message body may be given a first weighting while the matching of the search query terms within a title field or within the text of a referencing document (e.g., anchor text within a source document) may be given a second weighting different from the first weighting (e.g., greater than the first weighting). The scoring and ranking of a set of relevant documents may take into consideration document popularity, which may change over time as a document ages or as the number of views for a document within a past period of time (e.g., within the past week) increases or decreases. A higher document popularity score may increase the ranking of a document, while a lower document popularity score may signal that the document has become stale and that its importance should be demoted. The ranking modification pipeline 222 may score and rank a set of relevant documents based on user suggested results submitted by owners of the relevant documents, the document verification statuses of the relevant documents, and the amount and type of user activity performed within a past period of time (e.g., within the past 24 hours) by the user executing a search query and others that are part of a common grouping with the user (e.g., co-workers on the same team or assigned to the same group).

FIG. 2C depicts one embodiment of various components of the search and knowledge management system 220 of FIG. 2A. As depicted, the search and knowledge management system 220 includes hardware-level components and software-level components. The hardware-level components may include one or more processors 270, one or more memory 271, and one or more disks 272. The one or more memory 271 and the one or more disks 272 may comprise storage devices or hardware storage devices. The software-level components may include software applications and computer programs. In some embodiments, the data ingestion and index path 242, the ranking path 244, the query and response path 246, and the answer generation controller 248 may be implemented using software or a combination of hardware and software. In some cases, the software-level components may be run using a dedicated hardware server. In other cases, the software-level components may be run using a virtual machine or containerized environment running on a plurality of machines. In various embodiments, the software-level components may be run from the cloud (e.g., the software-level components may be deployed using a cloud-based compute and storage infrastructure).

In some embodiments, the answer generation controller 248 may determine when to leverage one or more generative AI models in order to generate summaries of search results. The answer generation controller 248 may also determine the number of search results and/or the amount of text per search result to provide to the one or more generative AI models based on latency requirements for providing responses to search queries.

As depicted in FIG. 2C, the software-level components may also include virtualization layer processes, such as virtual machine 273, hypervisor 274, container engine 275, and host operating system 276. The hypervisor 274 may comprise a native hypervisor (or bare-metal hypervisor) or a hosted hypervisor (or type 2 hypervisor). The hypervisor 274 may provide a virtual operating platform for running one or more virtual machines, such as virtual machine 273. A hypervisor may comprise software that creates and runs virtual machine instances. Virtual machine 273 may include a plurality of virtual hardware devices, such as a virtual processor, a virtual memory, and a virtual disk. The virtual machine 273 may include a guest operating system that has the capability to run one or more software applications, such as applications for the data ingestion and index path 242, the ranking path 244, and the query and response path 246. The virtual machine 273 may run the host operation system 276 upon which the container engine 275 may run.

A container engine 275 may run on top of the host operating system 276 in order to run multiple isolated instances (or containers) on the same operating system kernel of the host operating system 276. Containers may facilitate virtualization at the operating system level and may provide a virtualized environment for running applications and their dependencies. Containerized applications may comprise applications that run within an isolated runtime environment (or container). The container engine 275 may acquire a container image and convert the container image into running processes. In some cases, the container engine 275 may group containers that make up an application into logical units (or pods). A pod may contain one or more containers and all containers in a pod may run on the same node in a cluster. Each pod may serve as a deployment unit for the cluster. Each pod may run a single instance of an application.

FIG. 2D depicts another embodiment of various components of the search and knowledge management system 220 of FIG. 2A. The search and knowledge management system 220 of FIG. 2A may utilize one or more machine learning models to determine a selection and ranking of relevant documents. As depicted, the answer generation controller 248 includes prompt generator 278, machine learning model trainer 281, machine learning models 282, training data generator 283, and training data 284. The prompt generator 278 generates input prompt to be provided to generative Al models. The machine learning models 282 may comprise one or more machine learning models that are stored in a memory, such as memory 127 in FIG. 1 or memory 271 in FIG. 2C. The one or more machine learning models may be trained, executed, and/or deployed using one or more processors, such as processor 126 in FIG. 1 or processor 270 in FIG. 2C. The one or more machine learning models may include neural networks (e.g., deep neural networks), support vector machine models, decision tree-based models, k-nearest neighbor models, Bayesian networks, or other types of models such as linear models and/or non-linear models. A linear model may be specified as a linear combination of input features. A neural network may comprise a feed-forward neural network, recurrent neural network, or a convolutional neural network.

The search and knowledge management system 220 may also include a set of machines including machine 280 and machine 290. In some cases, the set of machines may be grouped together and presented as a single computing system. Each machine of the set of machines may comprise a node in a cluster (e.g., a failover cluster). The cluster may provide computing and memory resources for the search and knowledge management system 220. In one example, instructions and data (e.g., input feature data) may be stored within the memory resources of the cluster and used to facilitate operations and/or functions performed by the computing resources of the cluster. The machine 280 includes a network interface 285, processor 286, memory 287, and disk 288 all in communication with each other. Processor 286 allows machine 280 to execute computer readable instructions stored in memory 287 to perform processes described herein. Disk 288 may include a hard disk drive and/or a solid-state drive. The machine 290 includes a network interface 295, processor 296, memory 297, and disk 298 all in communication with each other. Processor 296 allows machine 290 to execute computer readable instructions stored in memory 297 to perform processes described herein. Disk 298 may include a hard disk drive and/or a solid-state drive. In some cases, disk 298 may include a flash-based SSD or a hybrid HDD/SSD drive.

In one embodiment, the depicted components of the search and knowledge management system 220 including the machine learning model trainer 281, machine learning models 282, training data generator 283, and training data 284 may be implemented using the set of machines. In another embodiment, one or more of the depicted components of the search and knowledge management system 220 may be run in the cloud or in a virtualized environment that allows virtual hardware to be created and decoupled from the underlying physical hardware.

The machine learning model trainer 281 may implement a machine learning algorithm that uses a training data set from the training data 284 to train the machine learning model and uses the evaluation data set to evaluate the predictive ability of the trained machine learning model. The predictive performance of the trained machine learning model may be determined by comparing predicted answers generated by the trained machine learning model with the target answers in the evaluation data set (or ground truth values). For a linear model, the machine learning algorithm may determine a weight for each input feature to generate a trained machine learning model that can output a predicted answer. In some cases, the machine learning algorithm may include a loss function and an optimization technique. The loss function may quantify the penalty that is incurred when a predicted answer generated by the machine learning model does not equal the appropriate target answer. The optimization technique may seek to minimize the quantified loss. One example of an appropriate optimization technique is online stochastic gradient descent.

In some embodiments, the training data 284 includes a set of training examples. In at least one example, each training example of the set of training examples includes an input-output pair, such as a pair comprising an input vector and a target answer (or supervisory signal). In another example, each training example of the set of training examples includes an input vector and a pair of outcomes corresponding with a first decision to perform a first action and a second decision to not perform the first action. In this case, each outcome of the pair of outcomes is scored and a positive label is applied to the higher scoring outcome while a negative label is applied to the lower scoring outcome.

The machine learning model trainer 281 may generate or train one or more language models for facilitating natural language processing. Natural language processing (NLP) refers to the ability of a computing system to process and analyze natural language data to understand human language that is written or spoken. For example, NLP tasks have the ability to be utilized to classify portions of text (e.g., topic detection or detecting that an email is spam or that a sentence is grammatically correct) and to generate textual content (e.g., auto-completing a prompt with generated text or generating a textual summary for a large portion of text).

A large language model (LLM) refers to a language model that comprises a neural network with a large number of parameters (e.g., millions or billions of parameters or weights). In order to reduce training time and cost, transfer learning can be utilized in which a pre-trained model is used as a starting point for a specific task and then trained or fine-tuned with a supervised dataset for the specific task. In one example, an LLM is pre-trained using a large dataset and then fine-tuned using a much smaller dataset to tailor the LLM to solve a specific task. Pretraining refers to the act of training a machine learning model from scratch without any prior knowledge using a large corpus of data. Fine-tuning refers to a transfer learning process that modifies a pretrained LLM by training the LLM in a supervised or semi-supervised manner. In some cases, the fine-tuning involves adapting a pretrained LLM for a specific task by fine-tuning the LLM using a task specific dataset.

In some cases, an LLM comprises a transformer model that is implemented using a transformer-based neural network architecture. A transformer model includes an encoder and/or a decoder. An encoder extracts features from an input sequence and a decoder uses the extracted features from the encoder to produce an output sequence. In some cases, an encoder comprises one or more encoding layers and a decoder comprises one or more decoding layers. Each encoding and decoding layer includes a self-attention mechanism that relates tokens within a sequence of tokens to other tokens within the sequence. In one example, the self-attention mechanism allows the transformer model to examine a word within a sentence and determine the relative importance of other words within the same sentence to the examined word. In some cases, an encoder includes a self-attention layer and a feed forward neural network layer and a decoder includes two self-attention layers and a feed forward neural network layer. In some cases, a transformer model (or transformer) utilizes an encoder-decoder architecture, an encoder only architecture, or a decoder only architecture.

One example of a transformer model is a Generative Pre-trained Transformer (GPT) model. A GPT model comprises a type of LLM that uses deep learning to generate human-like text. A GPT model is referred to as being “generative” because it generates new content based on a given input prompt (e.g., a text prompt), “pre-trained” because it is trained on a large corpus of data before being fine-tuned for specific tasks, and a “transformer” because it utilizes a transformer-based neural network architecture to process the input prompt to generate the output content (or response).

In some embodiments, a machine learning model is trained to generate a language text response (or completion) given an inputted text prompt. The inputted text prompt provides information to help guide the machine learning model to generate an appropriate text response. Prompt engineering can be used to alter or update the inputted text prompt such that the machine learning model generates a more relevant text response. In some cases, the text response is generated by predicting the next set of words in a sequence of words provided by the inputted text prompt using a transformer model, such as a GPT language model. In some cases, the transformer model is trained using sets of input prompt-response pairs.

Multimodal learning refers to a type of machine learning in which a machine learning model is trained to understand multiple forms of input data (e.g., text, images, video, and audio data) that derive from different modalities. Image data can include different types of images, such as color images, depth images, and thermal images. In some cases, a machine learning model comprises a multimodal model, a language model, or a visual model.

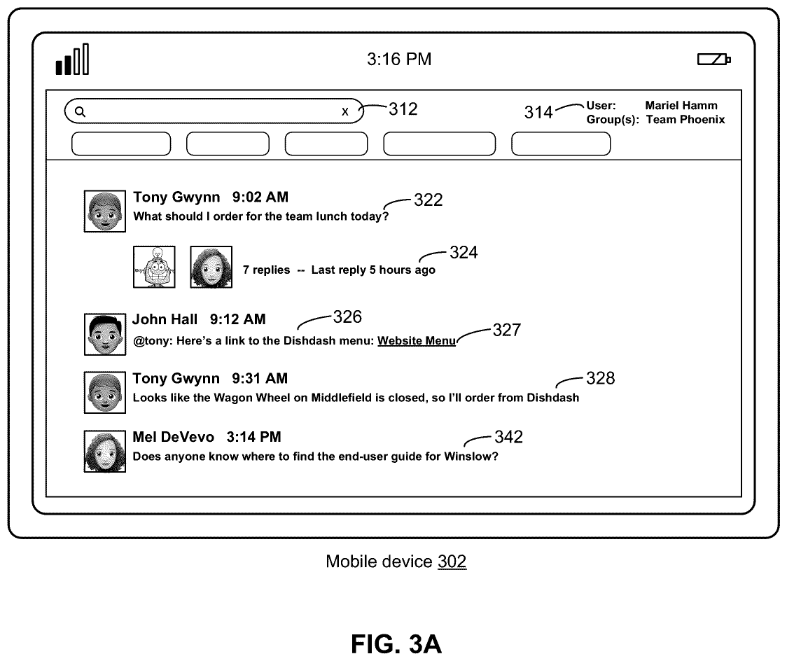

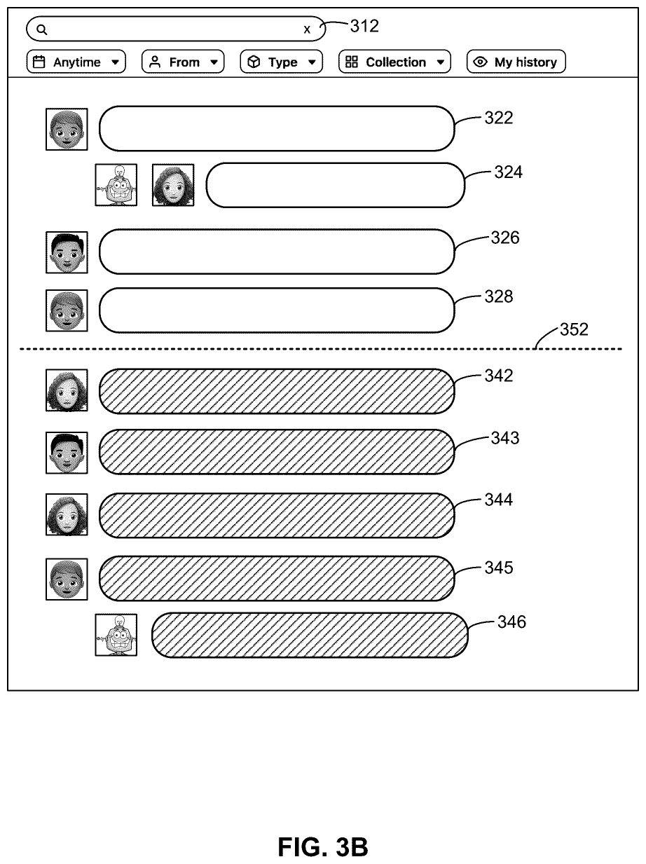

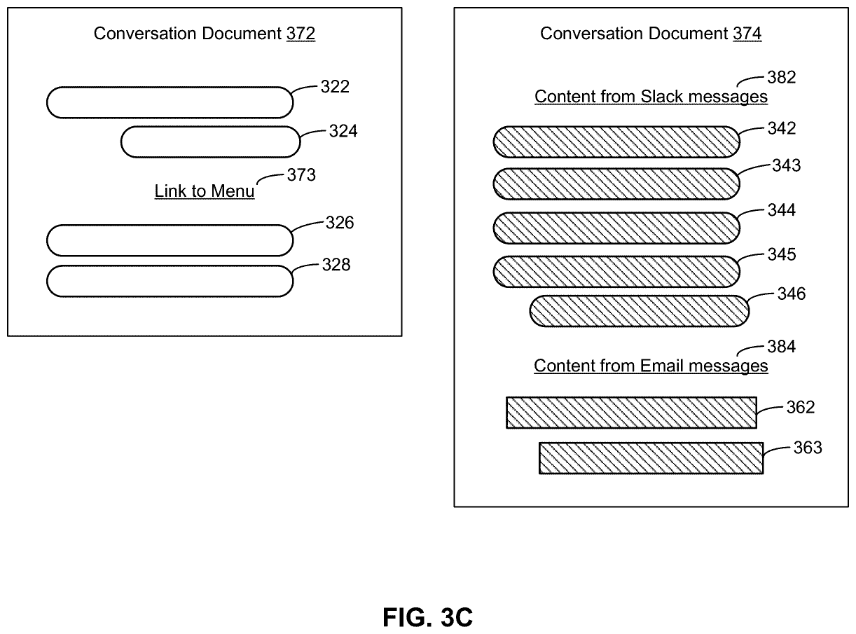

FIG. 3A depicts one embodiment of a mobile device 302 providing a user interface for posting, viewing, and interacting with messages within a chat channel. The mobile device 302 may correspond with the computing device 154 in FIG. 1. The user interface may be provided via a web-browser or an application running on the mobile device. The user interface may include a search bar 312 that an end user of the mobile device 302 may use to enter and submit a search query with search terms and criteria for retrieving content of searchable documents and messages, such as message replies 324 and messages 322, 326, 328, and 342. The end user of the mobile device 302 may be associated with a unique user identifier or username 314. The username 314 may map to one or more group identifiers or group names. For example, the username “Mariel Hamm” may map to a single group identifier “Team Phoenix.” A username may map to one or more group identifiers (e.g., a username may map to three different group identifiers associated with three different groups).

A group of messages may correspond with a conversation thread regarding a particular topic or subject. A conversation thread (or conversation) may comprise a collection of channel messages along with their message responses.

As depicted in FIG. 3A, a user Tony Gwynn has posted a message 322 asking a question about a team lunch. The message 322 may comprise the first message in a first group of messages or the root message for the first group of messages. In some cases, a generative model or a large language model (LLM) may be used to identify a topic or subject corresponding with the message 322. For example, a prompt such as “what is the topic of the following message:” may be used along with the message 322 to generate a response that includes the topic or subject corresponding with the message 322. The message 322 may be assigned to a first group of messages corresponding with a particular topic or subject. The message replies 324 comprise seven message replies to the message 322. As message replies, the message replies 324 may all be assigned to the first group of messages that message 322 has been assigned to. Message 326 is posted by user John Hall and includes a link 327 or reference to a document entitled Website Menu. The Website Menu document may include content that does not appear in any messages. Message 328 is posted by user Tony Gwynn. In some cases, the messages 322, 326, and 328 may be assigned to the first group of messages based on posting times and/or the usernames or user identifies associated with the messages 322, 326, and 328. In one example, any messages posted within 30 minutes of the message 322 may be assigned to the first group of messages. In another example, any message subsequent to the message 322 that was posted within 30 minutes (or another period of time) of a message assigned to the first group of messages may be assigned to the first group of messages subject to a limit to the maximum number of messages per grouping of messages (e.g., each group of messages may be limited to at most 50 messages). In another example, a set of usernames associated with the first group of messages may be determined based on messages posted within 30 minutes of the message 322; thereafter, if a new username that is not found in the set of usernames posts a new message, then that new message may be identified as a new root message for a new group of messages.

Message 342 is posted by user Mel DeVevo which asks a question about an end-user guide for Winslow. A generative model or an LLM may be used to identify a topic or subject corresponding with the message 342. As the topic or subject corresponding with the message 342 may be semantically different from the topic or subject corresponding with the message 322, the message 342 may be assigned to a second group of messages different from the first group of messages. The message 342 may comprise the first message in the second group of messages or the root message for the second group of messages. The identification of a new root message may correspond with a conversation boundary between the message 328 comprising the last message in the first group of messages and the message 342 comprising the first message in the second group of messages.

In one embodiment, it may be detected that the message 342 should be assigned to the second group of messages based on the topic or subject of the content of message 342. In another embodiment, it may be detected that the message 342 should be assigned to the second group of messages based on a time of posting of the message 342 relative to the root message 322 or the last message 328 in the first group of messages.

FIG. 3B depicts one embodiment of a first group of messages comprising messages 322, 324, 326, and 328 and a second group of messages comprising messages 342-346. A conversation boundary 352 is depicted separating the first group of messages from the second group of messages.

In some embodiments, the root message 342 of the second grouping of messages may be identified based on the time difference between the message 328 and the root message 342. For example, if the time difference is greater than 30 minutes, then a new root message for a new group of messages may be identified. In some embodiments, the root message 342 of the second grouping of messages may be identified based on the total number of messages within the first group of messages and a type of messaging channel in which the messages are posted. In one example, if the type of messaging channel comprises a messaging channel with less than a threshold number of subscribers (e.g., less than ten users are subscribed to the messaging channel), then the maximum number of messages for a group of messages may be set to a first number (e.g., 50); otherwise, if the messaging channel has more than the threshold number of subscribers, then the maximum number of messages for a group of messages may be set to second number less than the first number (e.g., 25). In some embodiments, the root message 342 of the second grouping of messages may be identified based on the total number of messages for a grouping of messages including both messages and message replies. In one example, a conversation boundary may be identified if a first group of messages has exceeded a threshold number of messages (e.g., comprises more than 50 messages).

The maximum number of messages per grouping may be set based on the number of users within a chat channel, the number of users who are subscribed to the chat channel, or the number of users who have posted messages to the chat channel within a threshold period of time (e.g., within the past hour). In one example, the maximum number of messages per grouping may be set to a first number (e.g., 50) if the number of users who are subscribed to the chat channel or the number of users who have posted messages to the chat channel within a threshold period of time is greater than ten users; otherwise, the maximum number of messages per grouping may be set to a second number (e.g., 25) less than the first number.

FIG. 3C depicts one embodiment of a first conversation document 372 and a second conversation document 374. The first conversation document 372 includes the message content from messages 322, 324, 326, and 328 that have been assigned to a first group of messages. In addition, heading text 373 may be automatically inserted into the first conversation document 372 prior to the first conversation document 372 being indexed or stored within a search index, such as the search index 204 in FIG. 2A. The heading text 373 may be generated based on a topic or subject for one or more messages within the first conversation document 372 or generated using a generative model to summarize a subset of the messages within the first conversation document 372. In one example, the heading text 373 may comprise a summary for the messages 326 and 328. Moreover, identification of the usernames that posted messages 322, 324, 326, and 328 may be embedded within the first conversation document 372.

The second conversation document 374 includes the message content from messages 342-346 and the message content from email messages 362-363. In this case, the second conversation document 374 includes both chat channel messages and email messages. In addition, header text 382 comprising a header for the messages 342-346 and header text 384 comprising a header for the email messages 362-363 have been inserted into the second conversation document 374 prior to being indexed or stored within a search index, such as the search index 204 in FIG. 2A.

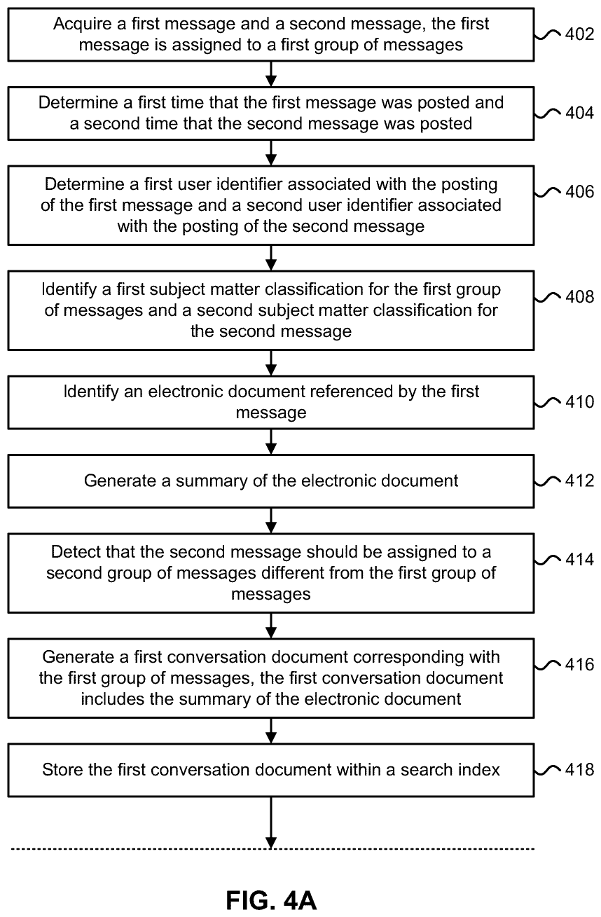

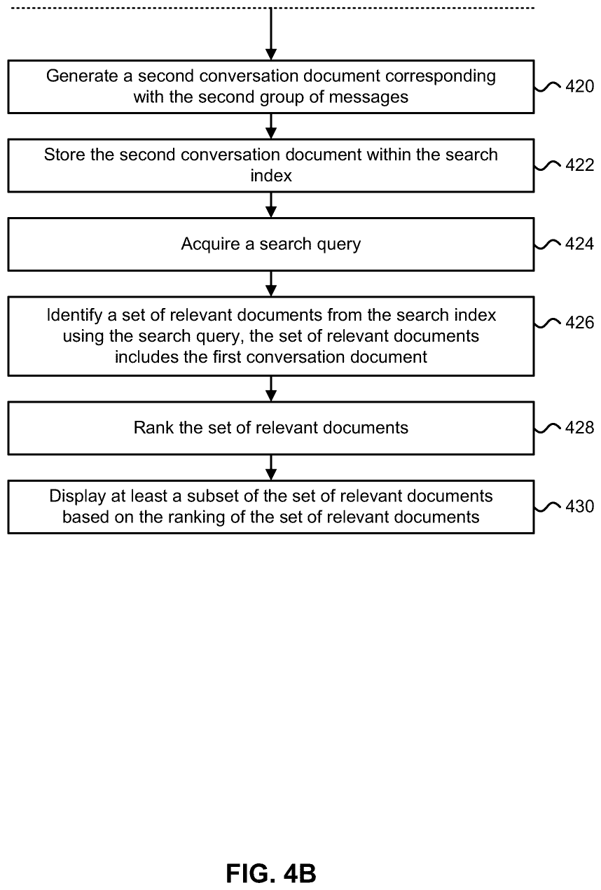

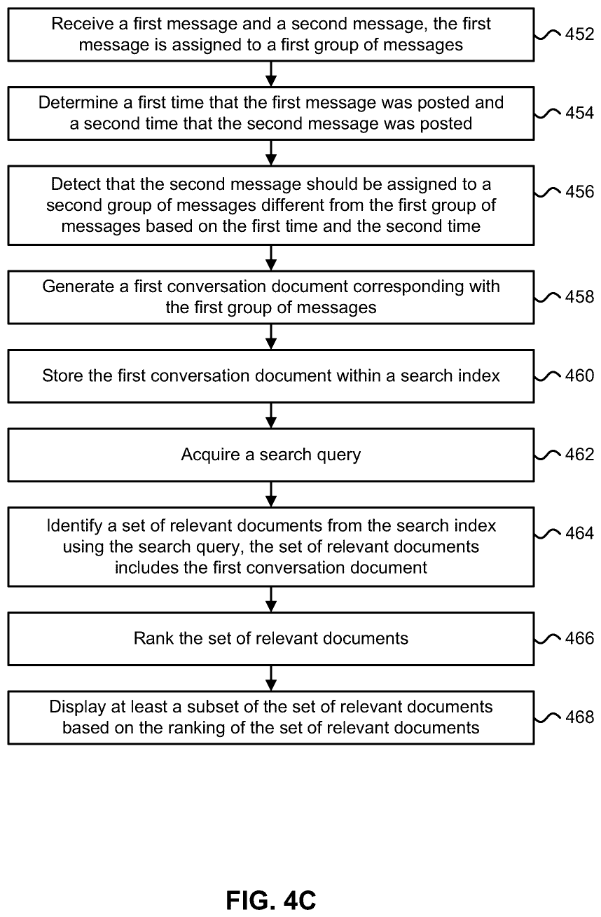

FIGS. 4A-4B depict a flowchart describing one embodiment of a process for generating, indexing, and utilizing conversation documents that aggregate electronic messages. In one embodiment, the process of FIGS. 4A-4B may be performed by a search and knowledge management system, such as the search and knowledge management system 120 in FIG. 1 or the search and knowledge management system 220 in FIG. 2A. In another embodiment, the process of FIGS. 4A-4B may be implemented using a cloud-based computing platform or cloud-based computing services.

In step 402, a first message and a second message are acquired. The first message and the second message may be acquired from a chat application in which the first message and the second message were posted. The first message is assigned to a first group of messages. In one example, the first message is assigned to the first group of messages based on the content of the first message being classified as belonging to a particular topic.

In step 404, a first time that the first message was posted is determined and a second time that the second message was posted determined. In step 406, a first user identifier associated with the posting of the first message is determined and a second user identifier associated with the posting of the second message is determined. The first user identifier may correspond with a first username and the second user identifier may correspond with a second username. In step 408, a first subject matter classification for the first group of messages is identified and a second subject matter classification for the second message is identified. In one example, the first subject matter classification may be identified via application of the first group of messages to an LLM or a generative model.

In step 410, an electronic document referenced by the first message is identified. In one example, the electronic document may correspond with the document reference by link 327 in FIG. 3A. In step 412, a summary of the electronic document is generated. The summary of the electronic document may be generated using a generative model and a prompt, such as “generate a summary of the following document” along with the contents of the electronic document. In step 414, it is detected that the second message should be assigned to a second group of messages different from the first group of messages.

In one embodiment, it is detected that the second message should be assigned to a new grouping of messages different from the first group of messages in response to detection that the first subject matter classification is different from the second subject matter classification. In another embodiment, it is detected that the second message should be assigned to a new grouping of messages different from the first group of messages in response to the second time that the second message was posted being more than a threshold amount of time past the first time that the first message was posted.

In step 416, a first conversation document corresponding with the first group of messages is generated. The first conversation document may include the summary of the electronic document or a portion thereof. In step 418, the first conversation document is stored within a search index. The search index may correspond with the search index 204 in FIG. 2A. In step 420, a second conversation document corresponding with the second group of messages is generated. In one example, the first conversation document may correspond with the first conversation document 372 in FIG. 3C and the second conversation document may correspond with the second conversation document 374 in FIG. 3C.

In step 422, the second conversation document is stored within the search index. In step 424, a search query is acquired. In step 426, a set of relevant documents from the search index is identified using the search query. The set of relevant documents includes the first conversation document. In step 428, the set of relevant documents is ranked. In step 430, at least a subset of the set of relevant documents is displayed based on the ranking of the set of relevant documents.

FIG. 4C depicts a flowchart describing one embodiment of a process for generating, indexing, and utilizing a conversation document. In one embodiment, the process of FIG. 4C may be performed by a search and knowledge management system, such as the search and knowledge management system 120 in FIG. 1 or the search and knowledge management system 220 in FIG. 2A. In another embodiment, the process of FIG. 4C may be implemented using a cloud-based computing platform or cloud-based computing services.

In step 452, a first message and a second message are received. The first message and the second message may be received from a messaging application or a chat application. In step 454, a first time that the first message was posted to the messaging application and a second time that the second message was posted to the messaging application is determined. The first time and the second time may be determined using metadata associated with the first message and the second message. In step 456, it is detected that the second message should be assigned to a second group of messages different from the first group of messages based on the first time and the second time. In one example, if the amount of time between the first time and the second time is greater than a threshold amount of time (e.g., is greater than 30 minutes), then it may be determined that the second message should be assigned to the second group of messages.

In step 458, a first conversation document corresponding with the first group of messages is generated. In one example, the first conversation document may correspond with the first conversation document 372 in FIG. 3C. In step 460, the first conversation document is stored within a search index, such as the search index 204 in FIG. 2A. In step 462, a search query is acquired. In step 464, a set of relevant documents from the search index is identified using the search query. The set of relevant documents may include the first conversation document. In step 466, the set of relevant documents is ranked. In step 468, at least a subset of the set of relevant documents is displayed or outputted based on the ranking of the set of relevant documents.

At least one embodiment of the disclosed technology includes receiving a first message that is assigned to a first group of messages; receiving a second message; determining a first time that the first message was posted to a chat channel; determining a second time that the second message was posted to the chat channel; detecting that the second message should be assigned to a second group of messages different from the first group of messages based on the first time that the first message was posted and the second time that the second message was posted; generating a first conversation document corresponding with the first group of messages; storing the first conversation document within a search index; acquiring a search query; identifying a set of relevant documents from the search index using the search query, the set of relevant documents includes the first conversation document; and displaying at least a subset of the set of relevant documents.

In some cases, the detecting that the second message should be assigned to the second group of messages different from the first group of messages includes detecting that the second message should be assigned to the second group of messages using a machine learning model.

In some cases, the method further comprises determining a first subject matter classification associated with contents of the first message; determining a second subject matter classification associated with contents of the second message; and detecting that the second message should be assigned to the second group of messages based on the first subject matter classification and the second subject matter classification.

At least one embodiment of the disclosed technology comprises a search system including a storage device (e.g., a semiconductor memory) and one or more processors in communication with the storage device. The storage device configured to store a search index. The one or more processors configured to acquire a first message assigned to a first group of messages; acquire a second message; determine a first time that the first message was posted and a second time that the second message was posted; detect that the second message should be assigned to a second group of messages different from the first group of messages based on the first time that the first message was posted and the second time that the second message was posted; generate a first conversation document corresponding with the first group of messages; store the first conversation document within the search index; acquire a search query; identify a set of relevant documents from the search index using the search query, the set of relevant documents includes the first conversation document; rank the set of relevant documents; and display at least a subset of the set of relevant documents based on the ranking of the set of relevant documents.

In some cases, the one or more processors are configured to detect a conversation boundary between the first group of messages and the second group of messages in response to detection that the second message should be assigned to the second group of messages different from the first group of messages. The one or more processors may be configured to detect the conversation boundary between the first group of messages and the second group of messages using a machine learning model.

In some cases, the one or more processors are configured to detect that the second message should be assigned to the second group of messages different from the first group of messages using a machine learning model.

The disclosed technology may be described in the context of computer-executable instructions being executed by a computer or processor. The computer-executable instructions may correspond with portions of computer program code, routines, programs, objects, software components, data structures, or other types of computer-related structures that may be used to perform processes using a computer. Computer program code used for implementing various operations or aspects of the disclosed technology may be developed using one or more programming languages, including an object oriented programming language such as Java or C++, a function programming language such as Lisp, a procedural programming language such as the “C” programming language or Visual Basic, or a dynamic programming language such as Python or JavaScript. In some cases, computer program code or machine-level instructions derived from the computer program code may execute entirely on an end user's computer, partly on an end user's computer, partly on an end user's computer and partly on a remote computer, or entirely on a remote computer or server.

The flowcharts and block diagrams in the figures provide illustrations of the architecture, functionality, and operation of possible implementations of systems, methods, and computer program products according to various aspects of the disclosed technology. In this regard, each step in a flowchart may correspond with a program module or portion of computer program code, which may comprise one or more computer-executable instructions for implementing the specified functionality. In some implementations, the functionality noted within a step may occur out of the order noted in the figures. For example, two steps shown in succession may, in fact, be executed substantially concurrently, or the steps may sometimes be executed in the reverse order, depending upon the functionality involved. In some implementations, steps may be omitted and other steps added without departing from the spirit and scope of the present subject matter. In some implementations, the functionality noted within a step may be implemented using hardware, software, or a combination of hardware and software. As examples, the hardware may include microcontrollers, microprocessors, field programmable gate arrays (FPGAs), and electronic circuitry.

For purposes of this document, the term “processor” may refer to a real hardware processor or a virtual processor, unless expressly stated otherwise. A virtual machine may include one or more virtual hardware devices, such as a virtual processor and a virtual memory in communication with the virtual processor.

For purposes of this document, it should be noted that the dimensions of the various features depicted in the figures may not necessarily be drawn to scale.

For purposes of this document, reference in the specification to “an embodiment,” “one embodiment,” “some embodiments,” “another embodiment,” and other variations thereof may be used to describe various features, functions, or structures that are included in at least one or more embodiments and do not necessarily refer to the same embodiment unless the context clearly dictates otherwise.

For purposes of this document, a connection may be a direct connection or an indirect connection (e.g., via another part). In some cases, when an element is referred to as being connected or coupled to another element, the element may be directly connected to the other element or indirectly connected to the other element via intervening elements. When an element is referred to as being directly connected to another element, then there are no intervening elements between the element and the other element.

For purposes of this document, the term “based on” may be read as “based at least in part on.”

For purposes of this document, without additional context, use of numerical terms such as a “first” object, a “second” object, and a “third” object may not imply an ordering of objects, but may instead be used for identification purposes to identify or distinguish separate objects.

For purposes of this document, the term “set” of objects may refer to a “set” of one or more of the objects.

For purposes of this document, the phrases “a first object corresponds with a second object” and “a first object corresponds to a second object” may refer to the first object and the second object being equivalent, analogous, or related in character or function.

For purposes of this document, the term “or” should be interpreted in the conjunctive and the disjunctive. A list of items linked with the conjunction “or” should not be read as requiring mutual exclusivity among the items, but rather should be read as “and/or” unless expressly stated otherwise. The terms “at least one,” “one or more,” and “and/or,” as used herein, are open-ended expressions that are both conjunctive and disjunctive in operation. The phrase “A and/or B” covers embodiments having element A alone, element B alone, or elements A and B taken together. The phrase “at least one of A, B, and C” covers embodiments having element A alone, element B alone, element C alone, elements A and B together, elements A and C together, elements B and C together, or elements A, B, and C together. The indefinite articles “a” and “an,” as used herein, should typically be interpreted to mean “at least one” or “one or more,” unless expressly stated otherwise.

The various embodiments described above in the Detailed Description can be combined to provide further embodiments. All of the U.S. patents, U.S. patent application publications, and U.S. patent applications referred to in this specification and/or listed in the Application Data Sheet are incorporated herein by reference, in their entirety. Aspects of the embodiments can be modified, if necessary to employ concepts of the various patents, applications and publications to provide yet further embodiments.

These and other changes can be made to the embodiments described above in the Detailed Description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A system, comprising:
a hardware storage device configured to store a search index; and
one or more processors in communication with the storage device configured to:
acquire a first message, the first message is assigned to a first group of messages;
acquire a second message;
determine a first time that the first message was posted to a chat channel and a second time that the second message was posted to the chat channel;
determine a maximum number of messages per grouping based on a number of users who have posted messages to the chat channel within a threshold period of time;
detect that the second message should be assigned to a second group of messages different from the first group of messages based on the first time that the first message was posted to the chat channel, the second time that the second message was posted to the chat channel, and the maximum number of messages per grouping;
identify an electronic document referenced by the second group of messages;
generate a summary of the electronic document using a generative model;
generate a second conversation document corresponding with the second group of messages that includes the summary of the electronic document;
store the second conversation document within the search index;
acquire a search query;
identify a set of relevant documents from the search index using the search query, the set of relevant documents includes the second conversation document;
rank the set of relevant documents; and
display at least a subset of the set of relevant documents based on the ranking of the set of relevant documents.

2. The system of claim 1, wherein:
the one or more processors are configured to detect a conversation boundary between the first group of messages and the second group of messages in response to detection that the second message should be assigned to the second group of messages different from the first group of messages.

3. The system of claim 2, wherein:
the one or more processors are configured to detect the conversation boundary between the first group of messages and the second group of messages using a machine learning model.

4. (canceled)

5. The system of claim 1, wherein:
the one or more processors are configured to determine a first user identifier associated with the first posting of the first message and a second user identifier associated with the posting of the second message; and
the one or more processors are configured to detect that the second message should be assigned to the second group of messages different from the first group of messages based on the first user identifier associated with the first posting of the first message and the second user identifier associated with the posting of the second message.

6. The system of claim 1, wherein:
the one or more processors are configured to identify a first subject matter classification for the first group of messages and a second subject matter classification for the second message; and
the one or more processors are configured to detect that the second message should be assigned to the second group of messages different from the first group of messages based on the first subject matter classification for the first group of messages and the second subject matter classification for the second message.

7. (canceled)

8. (canceled)

9. (canceled)

10. The system of claim 1, wherein:
the first group of messages comprises a set of contiguous messages within a messaging application.

11. The system of claim 1, wherein:
the second message comprises a root message for the second group of messages.

12. The system of claim 1, wherein:
the first group of messages comprises messages from a first application; and
the second group of messages comprises messages from a second application.

13. The system of claim 1, wherein:
the one or more processors are configured to detect that the first group of messages has exceeded the maximum number of messages per grouping and detect that the second message should be assigned to the second group of messages different from the first group of messages based on detection that the first group of messages has exceeded the maximum number of messages per grouping.

14. The system of claim 13, wherein:
the threshold period of time comprises one hour.

15. A method for operating a search system, comprising:
receiving a first message that is assigned to a first group of messages;
receiving a second message;
determining a first time that the first message was posted to a chat channel;
determining a second time that the second message was posted to the chat channel;
determining a maximum number of messages per grouping based on a number of users who have posted messages to the chat channel;
detecting that the second message should be assigned to a second group of messages different from the first group of messages based on the first time that the first message was posted to the chat channel, the second time that the second message was posted to the chat channel, and the maximum number of messages per grouping;
identifying an electronic document referenced by the second group of messages;
generating a summary of the electronic document using a generative model;
generating a second conversation document corresponding with the second group of messages that includes the summary of the electronic document;
storing the second conversation document within a search index;
acquiring a search query;
identifying a set of relevant documents from the search index using the search query, the set of relevant documents includes the second conversation document; and
displaying at least a subset of the set of relevant documents.

16. The method of claim 15, wherein:
the detecting that the second message should be assigned to the second group of messages different from the first group of messages includes detecting that the second message should be assigned to the second group of messages using a machine learning model.

17. The method of claim 15, further comprising:
determining a first subject matter classification associated with contents of the first message;
determining a second subject matter classification associated with contents of the second message; and
detecting that the second message should be assigned to the second group of messages based on the first subject matter classification and the second subject matter classification.

18. (canceled)

19. (canceled)

20. One or more non-transitory storage devices containing processor readable code for configuring one or more processors to perform a method for operating a search system, wherein the processor readable code configures the one or more processors to:
acquire a first message from a messaging application, the first message is assigned to a first group of messages;
acquire a second message from the messaging application;
determine a first time that the first message was posted within the messaging application;
determine a second time that the second message was posted within the messaging application;
determine a maximum number of messages per grouping based on a number of users who have posted message within the messaging application;
detect that the second message should be assigned to a second group of messages different from the first group of messages based on the first time that the first message was posted within the messaging application, the second time that the second message was posted within the messaging application, and the maximum number of messages per grouping;
identify an electronic document referenced by the second group of messages;
generate a summary of the electronic document using a generative model;
generate a second conversation document corresponding with the second group of messages;
store the second conversation document within a search index;
acquire a search query;
identify a set of relevant documents from the search index using the search query, the set of relevant documents includes the second conversation document; and
display at least a portion of the set of relevant documents.
